(19) United States
(12) Patent Application Publication
(10) Pub. No.: US 2025/0078021 A1
(43) Pub. Date: Mar. 6, 2025

(54) SYSTEMS AND METHODS FOR ADDING A NEW ITEM TO A CONTACTLESS SALES SYSTEM

(71) Applicant: ALWAYSAI, INC., Solana Beach, CA (US)

(72) Inventors: Todd GLEED, San Marcos, CA (US); Shesh MALI, Carlsbad, CA (US); Eric VANBUHLER, San Diego, CA (US)

(21) Appl. No.: 18/461,279

(22) Filed: Sep. 5, 2023

(51) Int. Cl. G06Q 10/087; G06T 5/00; G06T 7/70; G06V 10/25

(52) U.S. Cl. CPC G06Q 10/087; G06T 5/77; G06T 7/70; G06V 10/25; G06T 2207/20132; G06V 2201/07

(57) ABSTRACT

Systems and methods are provided for adding a new item to a contactless sales system. The system can receive a plurality of images containing an object of interest located in virtual zones of the image. Each image can be cropped to contain the object of interest and associated metadata including localized zone and object information, such as SKU or name. The system can sort each image to a plurality of asset bins, wherein each asset bin corresponds to one of the one or more objects of interest. These asset bins can be added to a repository.

### CROSS-REFERENCE TO RELATED APPLICATION

This application is related to U.S. Application Ser. Number [XX/XXX,XXX] (Attorney Docket No. 77CW-363382-US), which is hereby incorporated herein by reference in its entirety.

### TECHNICAL FIELD

The present disclosure relates generally to programmatically altering contactless systems with improved object recognition methods and processes.

### DESCRIPTION OF RELATED ART

Objects can be represented digitally for/within online systems, e.g., retail sales systems, and inventories so that users, e.g., store owners, inventory personnel, etc., can monitor the addition/removal of such objects to/from the system, e.g., as a result of inventory stocking or the purchasing of an object(s). In particular, objects such as retail products can be automatically identified in contactless sales systems to update inventory as users purchase items. During a sale of one of these products, the sale can be associated with the digital representation to update databases for inventory or product identification. However, tracking the sale/stocking of objects in conventional contactless sales system often necessitates the use of scanners and special product identifiers such as “quick-response” (QR) codes or barcodes that are tailored to the specific system.

### BRIEF SUMMARY OF THE DISCLOSURE

In accordance with one embodiment, a computer-implemented method comprises: receiving an image depicting a retail product; identifying the retail product in the image; localizing the retail product in the image by zone; storing the metadata of the retail product in the image; cropping the image about the retail product such the image is bounded by the dimensions of the product; adding the cropped image to an asset bin designated for storing assets pertaining to the retail product; and adding the asset bin to a repository of asset bins, the repository comprising a database of retail products.

In some embodiments, the image comprises one or more controlled zones that are subsets of the image.

In some embodiments, the method further comprises: receiving a second image depicting the retail product; localizing and identifying the retail product in the second image; cropping the second image about the retail product such that only pixels remain that are associated with the retail product; and adding the cropped form of the second image to an asset bin corresponding to the respective retail product.

In some embodiments, the method further comprises: receiving an additional plurality of images; and determining that a number of total images exceeds a threshold number of needed images.

In some embodiments, the method further comprises displaying information on a client device indicating that sufficient images have been received.

In some embodiments, the image comprises alpha channel pixels.

In some embodiments, cropping the image comprises replacing pixels that do not contain the retail product with zero value alpha channel pixels.

In some embodiments, the image comprises metadata, wherein the metadata comprises camera identifiers, subzone identifiers, and item identifiers.

In some embodiments, item identifiers comprise at least one of SKU numbers, item name, and item shape.

In some embodiments, item identifiers are determined by receiving information from a client device indicating an item identifier.

In some embodiments, adding the asset bin to the repository comprises adding the asset bin to a configuration file in the repository.

In accordance with one embodiment, a system can comprise a plurality of cameras; a memory; and at least one processor configured to execute machine-readable instructions stored in the memory to: receive an image comprising alpha channel pixels; localize a retail product depicted in the image; crop the image by replacing pixels that do not contain the retail product with zero value alpha channel pixels; sort the image to an asset folder corresponding to the retail product; and add the asset folder to a repository.

In some embodiments, the image comprises one specific zone that is a subset of the image.

In some embodiments, the machine-readable instructions further cause the at least one processor to: receive a second image depicting the retail product; identify the retail product in the second image; localize the retail product in the second image; generate metadata about the retail product; crop the second image about the retail product such that the image size corresponds to the pixels containing the retail object; and add the second image to an asset bin corresponding to a respective retail product.

In some embodiments, the machine-readable instructions further cause the at least one processor to: receive an additional plurality of images; and determine that a number of total images exceeds a threshold number of needed images.

In some embodiments, the machine-readable instructions further cause the at least one processor to display information on a client device indicating that sufficient images have been received.

In some embodiments, the image comprises metadata, wherein the metadata comprises camera identifiers, subzone identifiers, and item identifiers.

In some embodiments, item identifiers comprise at least one of SKU numbers, item name, and item shape.

In some embodiments, item identifiers are determined by receiving information from a client device indicating an item identifier.

In some embodiments, the machine-readable instructions further cause the at least one processor to add the asset folder to a configuration file in the repository.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A and 1B are a schematic representation of the system architecture in accordance with various embodiments.

FIGS. 2A-2D illustrate example scenarios of object identification or monitoring across multiple cameras in accordance with various embodiments.

FIG. 3 is a flow chart illustrating example operations to add an item to the system in accordance with various embodiments.

FIG. 4 illustrates an example environment for adding an item to the system in accordance with various embodiments.

FIG. 5 is an example computing component that may be used to implement various features of embodiments described in the present disclosure.

The figures are not exhaustive and do not limit the present disclosure to the precise form disclosed.

### DETAILED DESCRIPTION

Contactless sales systems, with which a consumer can effectuate a purchase without human assistance can be beneficial for various reasons, including increased transaction speeds, increased data privacy of transactions, and improved inventory regulation. Traditional contactless sales systems typically rely on small barcodes or “stock keeping unit” (SKU) numbers, resulting in delays where the consumer or employee has to find the respective barcode to properly scan the item. Indeed, a precise orientation of the object is required when detecting a SKU or barcode. Furthermore, there is no guarantee that the scanners will correctly read the SKUs and barcodes. Physical wear and tear to the product can easily prevent a scanner from properly identifying a product. A scanner may also identify a product completely different from the actual product because of a SKU or barcode even though it is plainly apparent what the product actually is from the object's physical appearance.

In the context of shipping retail products, this can cause an incorrect product to be shipped to a consumer. This can cause significant delays as the user has to return the product and receive a new shipment. Similar issues can arise when adding items to inventory by scanning barcodes and/or logging the item into the system. If a product is incorrectly added to the inventory, each product may have to be scrutinized further to find the correct relationship between a barcode/SKU and a product. There is no guarantee that a product has the correct barcode or SKU. Two of the same type of product may receive copies of barcodes, meaning the correct inventory of a particular product is unclear or inaccurate. Indeed, by adding a barcode or SKU to a product, significant effort may be required to correctly form relationships between a barcode and an individual product. Identifying a product without a SKU or barcode can assist in simplifying the inventory process and save a lot of time that would have been spent finding and scanning a correct SKU. As the inventory increases (i.e., thousands of products), the time saved becomes more apparent.

The embodiments described herein comprise a system such as a contactless sales system that can eliminate this delay by identifying objects at various angles or positions so that items can be programmatically added to inventory or sold to consumers quickly. In particular, the contactless sales system can recognize an object's plain appearance using one or more cameras focused on a target area. An object can be placed in the target area to be imaged by the cameras. Using image processing, the object can be added to inventory or recognized as an object in the inventory without the need for additional QR codes and/or pinpoint scanners. The image of the product can be analyzed using machine learning models and associated with the appropriate product, including additional identifiers such as type of product, SKU, shape, etc. Once the system comprises various objects and their identifiers, the system can generate datasets using images of the objects, which in turn can assist in improved training of the machine learning models for future recognition of objects. Once the dataset is trained, the resulting machine learning model can identify and localize the objects of interest on which it has been trained.

As mentioned above, embodiments can receive a plurality of images from one or more cameras. Each image can be divided into zones, or virtual dividers such as a grid or similar cross-sections. Each zone may comprise a target area that can receive multiple objects simultaneously and identify each object. Multiple cameras can be aimed at the same field of view of a zone, which can be divided into subzones to sort collected items. Embodiments can identify one or more objects of interest in each image, such as consumer goods, shapes, textures, or other object identifiers. The system can crop each image to contain the one or more objects of interest without extraneous background. These cropped images can be sorted into asset bins corresponding to objects of interest to allow machine learning models to use the assets from within those folders to train the system and identify future identical or similar objects. These asset folders can be added to a central repository that can store this inventory data.

Before describing various embodiments in greater detail, it would be useful to define or explain certain terminology used throughout the present disclosure. The term “camera/view/field of view” can refer to the view frustrum (or the plane or spatial view thereof) of the camera. The term “mainzone” can refer to the entire viewing area or some polygonal region of the viewing area. The association of the polygonal region of the viewing frame may be a technical limitation of the camera and not a limitation of the system. Rather, the mainzone may correspond with any shape identified by the system. Each camera of the system covers the mainzone from a different perspective or angle. The term “subzone” can refer to one or subsets/subdivisions of a mainzone, and may not extend outside of the mainzone. Subzones need not share boundaries with either the mainzone or other subzones. In some examples, the boundaries of the mainzone and one or more subzones may be determined manually by the user interacting with a user interface and/or being stored by the system.

In some examples, the cameras or other devices may be moved around the area of operation (e.g., in an autonomous vehicle use case, in a retail or warehouse environment, etc.). Physically moving the cameras may automatically (or manually) alter the subzone and/or corresponding mainzone and one or more subzones. In this example, the monitored area may be adjusted.

Technical improvements are described throughout. For example, the ability of cameras to detect identifiers of the item may provide enhanced image recognition of the items and improve analytics of the item for the system overall. The system may be prevented from incorrectly processing product sales when an incorrect product is identified from an identifier that has deteriorated over time, thus saving bandwidth and processing capabilities of the system for other actions. Other improvements related to improved training of machine learning models and more efficient model-based processing.

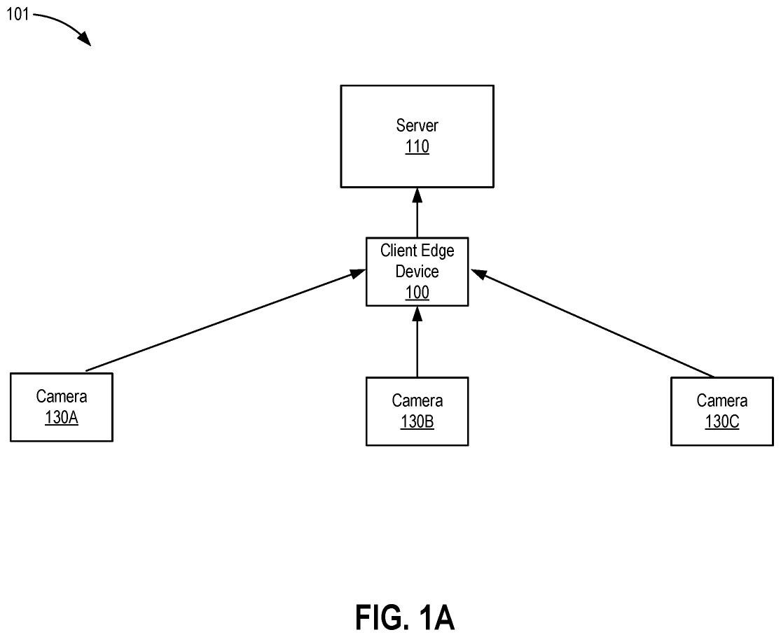

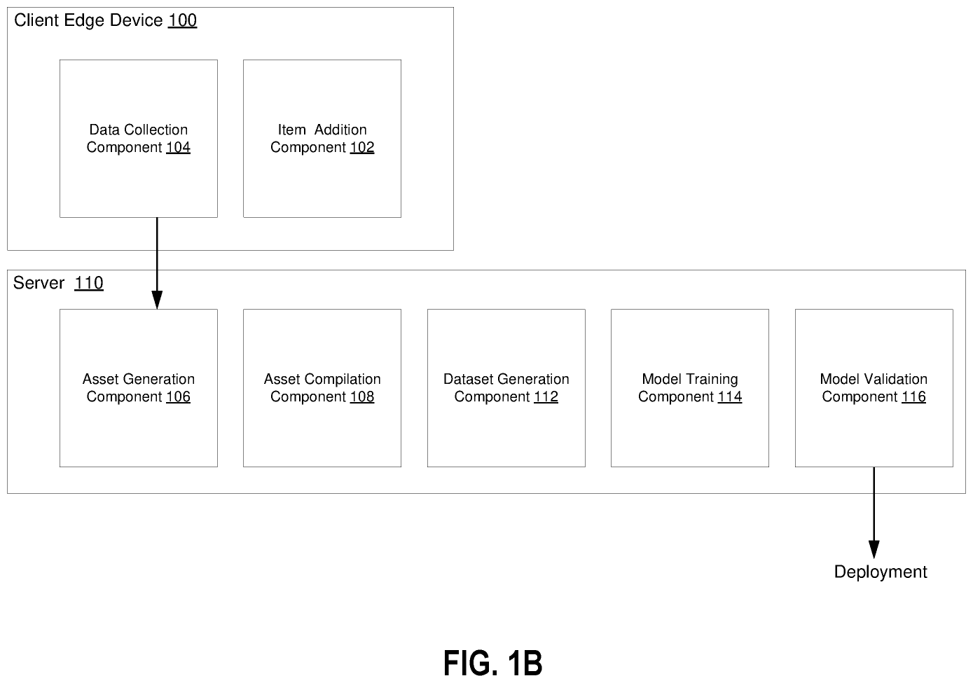

FIG. 1A illustrates an example system, in accordance with various embodiments. In example 101, three cameras 130 are illustrated, including first camera 130A, second camera 130B, and third camera 130C. Cameras 130 may comprise functionality to capture a perspective of the mainzone. A particular object can be any entity within the field of view (FOV) of a zone. Each camera 130A, 130B, and 130C may be operatively connected with a corresponding client edge device, e.g., client edge device 100. This camera-client edge device set may comprise a local cluster of imaging systems, each of which report collected data to server 110. That is, the data that has been gathered by client edge device 100, via its respective camera 130A, 130B, and 130C, can be transmitted or forwarded to server 110 to be aggregated, and where objects can be added to the system (described in greater detail below).

FIG. 1B illustrates an example implementation of client edge device 100 and server 110 in accordance with various embodiments. Items can be added to the system as new data by item addition component 102. Item addition component 102 can receive images from one or more cameras and transmit the data to data collection component 104. Data collection component can aggregate data/images and transmit it to asset generation component 106 in server 110. Asset generation component 106 can form assets out of images of objects of interests. An asset can comprise an image of the object of interest with all background material removed. For example, if an image shows a bottle of a water, the image can be cropped so that only pixels containing the water bottle are preserved. Each asset can comprise metadata on an object identifier, location, camera used, or other identifiers. Assets can be compiled as a configuration record at asset compilation component 108.

The configuration file can be used alongside the assets of objects of interest to generate a dataset at dataset generation component 112. Dataset generation component 112 can form a dataset for model training component 114. The purpose of the dataset can be to balance the training of each object of interest for the machine learning model component. Datasets can be formed using classes that balance the application of each object of interest, described further below. Model training component 114 can train the machine learning model to recognize objects of interest based on images taken at various angles and settings. The training can be tailored to focus on objects that are in close proximity. For example, it can be challenging for a machine learning model to detect two separate objects when the two objects are touching. The datasets generated at dataset generation component 112 can place objects of interest in close proximity to train the model to separate objects in a target area. The machine learning model can be trained and subsequently validated at model validation component 116. Server 110 can then deploy the trained model to an end device to be applied to detect objects placed into a sensing or target area. For example, an end device may be a unit at a retail store that can comprise one or more cameras/sensors to detect objects. Objects placed in a target area can be sensed and automatically identified, allowing retail systems to make updates to online inventories or transaction systems.

In some examples, “edge processing” or “edge computing” may be implemented. Edge processing or edge computing can refer to the execution of aggregation, data manipulation, or other processing or compute logic as close to the physical system as possible (e.g., as close to the sensor, in this case, the camera). In this way, response times, bandwidth, etc. can be reduced or saved. For example, in some conventional machine learning or Internet of Things (IoT) systems, data may be collected at the edge of a network, via edge nodes/sensors, and then transmitted to a centralized processor or server to be analyzed, annotated, and so on. There may also be a programmatic delay or inefficiency to transmit such data (both from a monetary and resource-usage perspective). Accordingly, various embodiments employ client edge devices (e.g., client edge devices 100) to perform at least some compute operations or processing (e.g., the aforementioned aggregating of images or frames, the creation of object-specific galleries, etc.).

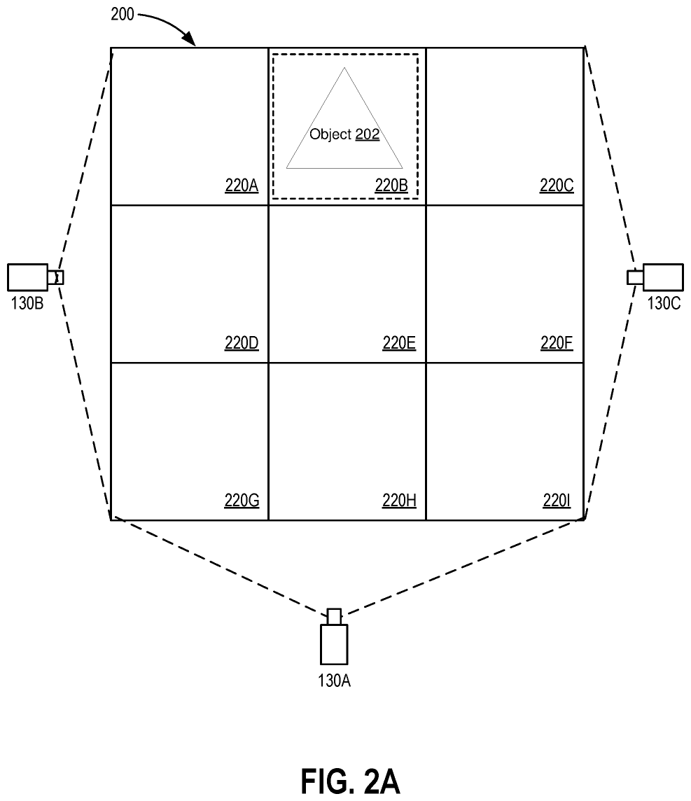

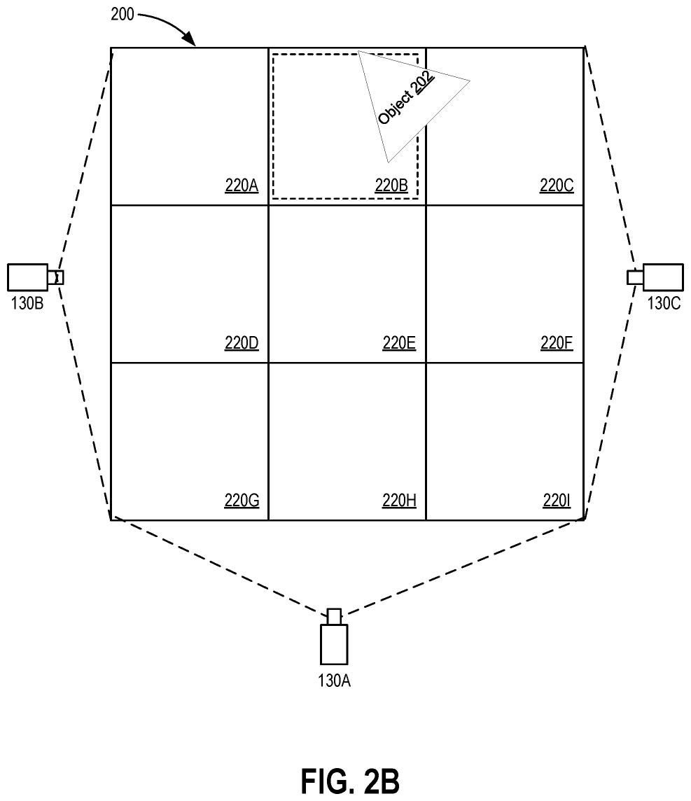

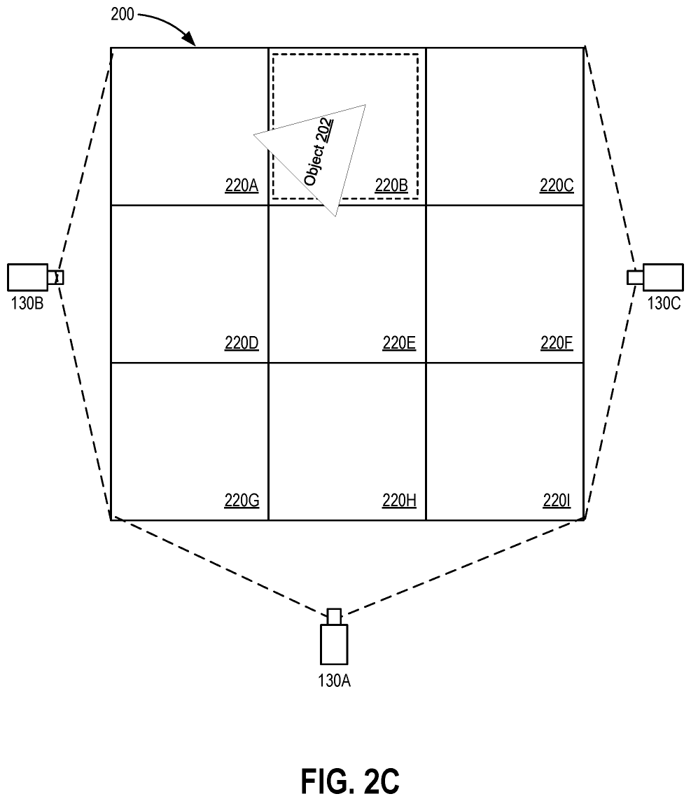

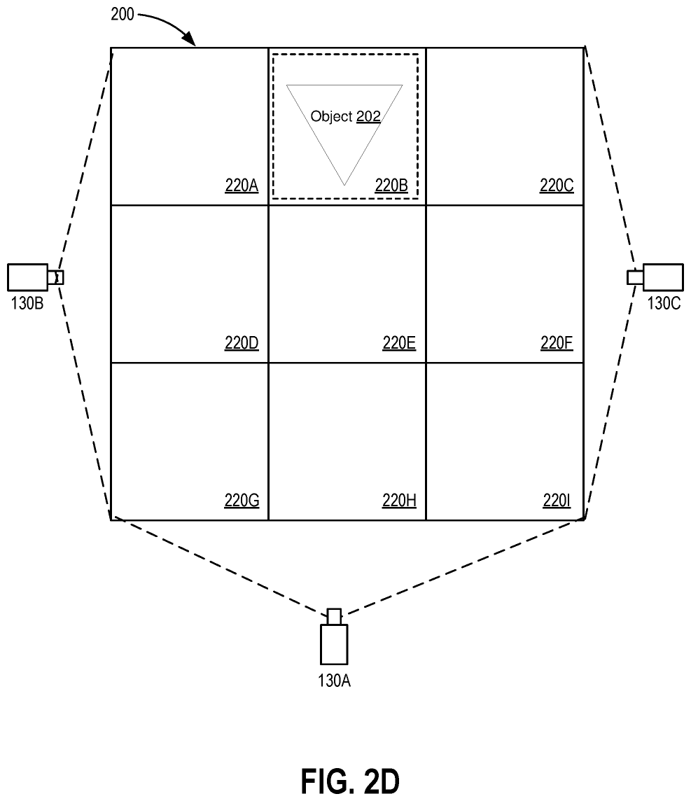

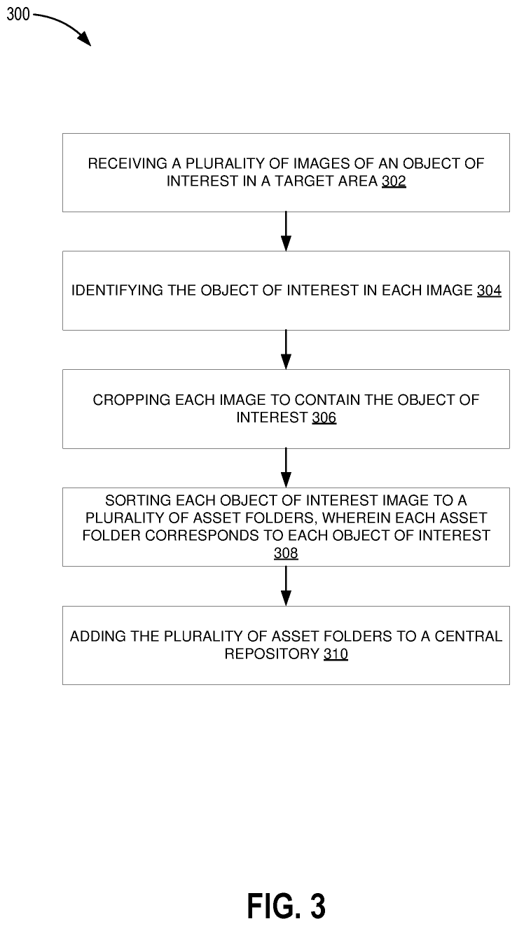

FIGS. 2A-2D illustrate another example scenario of object identification or monitoring across multiple cameras 130 in accordance with various embodiments. FIGS. 2A-2D will be described in conjunction with FIG. 3, which illustrates an example method using the scenario illustrated in FIGS. 2A-2D.

An object of interest 202 may be detected in area 200. Area 200 can be divided in one or more subzones 220 (illustrated as first subzone 220A, second subzone 220B, third subzone 220C, fourth subzone 220D, fifth subzone 220E, sixth subzone 220F, seventh subzone 220G, eighth subzone 220H, and ninth subzone 220I). In this example, there are nine subzones 220 that may contain objects within them. A particular object 202 may occupy more than one subzone, as shown with FIG. 2B, or multiple subzones, as shown with FIG. 2C. Each of FIGS. 2B and 2C shows object 202 occupying multiple subzones 220.

Once an image of object 202 has been captured, it can be rearranged on the target area within the same subzone, as seen in FIG. 2D or in a new subzone. One photograph can be taken for each position, with one or more cameras (e.g. cameras 130) at multiple, different angles. This enables the system to receive multiple perspectives of each object within a subzone.

FIG. 3 is a flow chart illustrating example operations to add an item to the system in accordance with various embodiments. In example 300, a server 110 illustrated in FIG. 1 may perform the actions described herein, including receiving images from cameras 130 via client edge device 100. These and other features of the system are provided for illustrative purposes.

At block 302, the system can receive a plurality of images of an object of interest within one or more subzones of a target area. A particular subzone deemed important to the environment may have extra images captured for an object of interest. Alternatively, each subzone may have the same number of images. These images may be captured automatically or may be initiated by a client device user.

Each image can contain metadata. The metadata can comprise the camera used, the subzone, and/or an item identifier. Each object can be identified in the subzone images with the item identifier. A user can identify the object by input to the client device. Alternatively, image processing techniques can be used to identify items of interest.

At block 304, the system can identify one or more objects of interest in each image with the item identifiers. Item identifiers can comprise product names, SKUs, barcodes, labels, item shape, or other distinguishing characteristics for the object. As opposed to conventional contactless sales systems, SKUs, and barcodes may not be necessary to identify the object, and the system can identify objects using one or more different item identifiers as necessary. For example, when an object is placed in a particular zone of the target area, a barcode may not be in a camera's view. If the object's shape is in view of the camera, the system can identify the object based on the object shape, color, or material, or it can be identified with user input. One object may be limited to a subzone, or an item identifier may correspond to an object taking a majority of space in the subzone. A client device may receive information relating to the metadata described above. In particular, information can comprise the total number of images collected for each subzone and/or the total number of images collected for each object. A threshold number of images may be set so as to limit the number of images taken. Once this threshold is reached or exceeded, the client device may display information indicating that enough images were collected. A user can designate a threshold for image collection for a particular object. The client device may then separately display information indicating that enough images were collected for the object of interest.

At block 306, the system can crop each subzone image to contain the object of interest. Areas of the image that do not contain an item can be replaced with transparency. For example, the transparency process performed by the system may replace pixels around the edge of the object with a “0” value for alpha channel pixels. The border of the object can be determined based on the image processing techniques described above. The remaining image can be saved as an image type that can retain the alpha channel values (e.g. PNG images, etc.). As the image is processed, the image can retain the metadata described above (e.g. camera, zone, and item identifier). Therefore, the final image can comprise an image showing only the object of interest and tagged with the camera, zone, and/or an item identifier.

At block 308, the system can sort each subzone image to a plurality of asset bins, wherein each asset bin corresponds to each of the one or more objects of interest. Each asset can comprise a collection of images from each zone in the target area, with reference to the metadata. Images in each asset folder may be sorted by item identifier, object type, or other metadata information. An asset folder can correspond to an object in the target area such that the system can retain images of the object from various perspectives and locations.

At block 310, the asset folders can be added to a central repository. Each asset folder can be assigned a category for use in dataset generation and/or can be added to a configuration file for targeted dataset. Each asset folder may comprise the same metadata structure with differences in the item identifiers. The folders can be manipulated for future image and data processing, such as inventory, sales, or other purposes for the central repository.

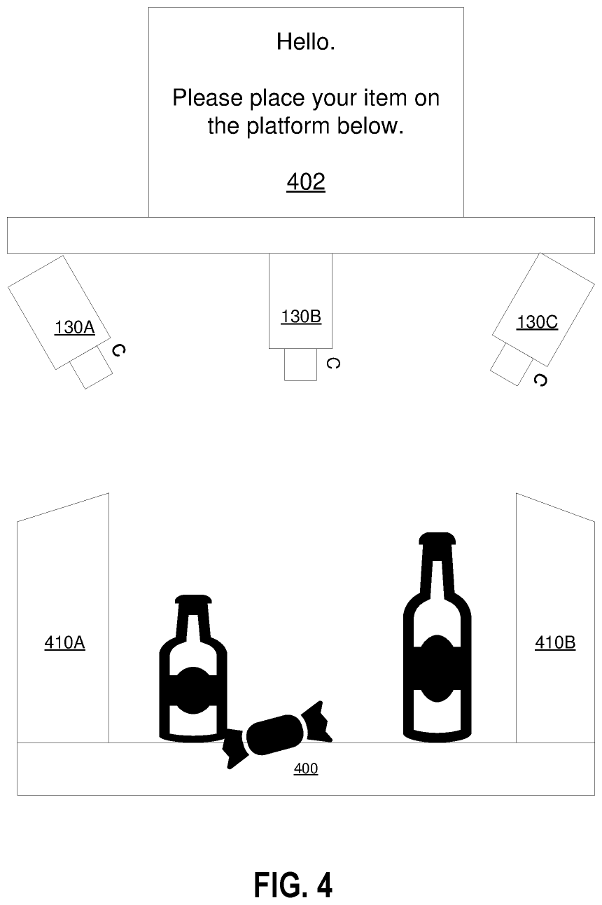

FIG. 4 illustrates an example environment for implementing the systems described herein. In this example, staging area 400 can contain the target area and respective subzones. To contain the target area and its respective objects, staging area 400 may comprise physical boundaries 410 to limit a camera's FOV, as illustrated by first physical boundary 410A and second physical boundary 410B, in addition to the platform of the staging area 400. Multiple cameras may be positioned to capture the target area (e.g. cameras 130A-C).

Interface 402 can direct users to place objects in the target area. An object of interest can be placed systematically on staging area 400, such that a plurality of images can be captured of the object in each of the designated zones. Interface 402 may direct users to turn the objects or move certain objects as necessary to generate additional images of different angles. Interface 402 can direct users to label images in accordance with the conventions described herein, or may request user input to determine what asset folder/bin each image is to be sorted to.

As described above, a user can place objects of interest into staging area 400 at one or more orientations. As described above, the target area may be accompanied with a structure comprising one or more cameras/sensors to capture objects. Users can place objects in the target area and interact with the hardware to scan and capture the objects. Interface 402 can prompt the user to take images of the objects using the one or more cameras. Once a threshold number of images is received, the kiosk can prompt the user to identify one or more item identifiers associated with the object. The system can assist in generating an asset for each object of interest by compiling the images with item identifiers and similar photographs, as described above. If all assets have been added to the system, the system can generate datasets to train the machine learning model to recognize each object of interest and associate the correct item identifiers. For example, a dataset may comprise an image of the target area with multiple instances of an object placed in the environment. The system can generate datasets such that each object of interest trains the machine learning model equally to prevent biases in item identification. These datasets can be sent to a server to train the machine learning model. After training is complete, the trained machine learning model can be deployed back to the system. The system can then prompt the user to place objects in the target area for purposes of item identification as opposed to asset generation.

These units can be implemented in retail stores or other locations associated with object inventories or the transfer of products. As mentioned above, retail staff can use the unit to generate the appropriate inventory. Consumers can use the system after the trained machine learning model is transmitted to the unit. The system may primarily serve to assist consumers after the model is trained, although as new items are added to the physical inventory, retail staff can use the system to add additional assets to account for the new items. The system can generate additional datasets to retrain the model as needed to account for these new assets. The newly trained machine learning model can be transmitted to the kiosk to update operation automatically after retraining occurs. Therefore, the kiosk can allow items to be added to the inventory without sacrificing equal training for the machine model. As changes are made to online inventory, either through system identification or through asset addition, the inventories can be automatically updated with retrained learning models without prompting from a user.

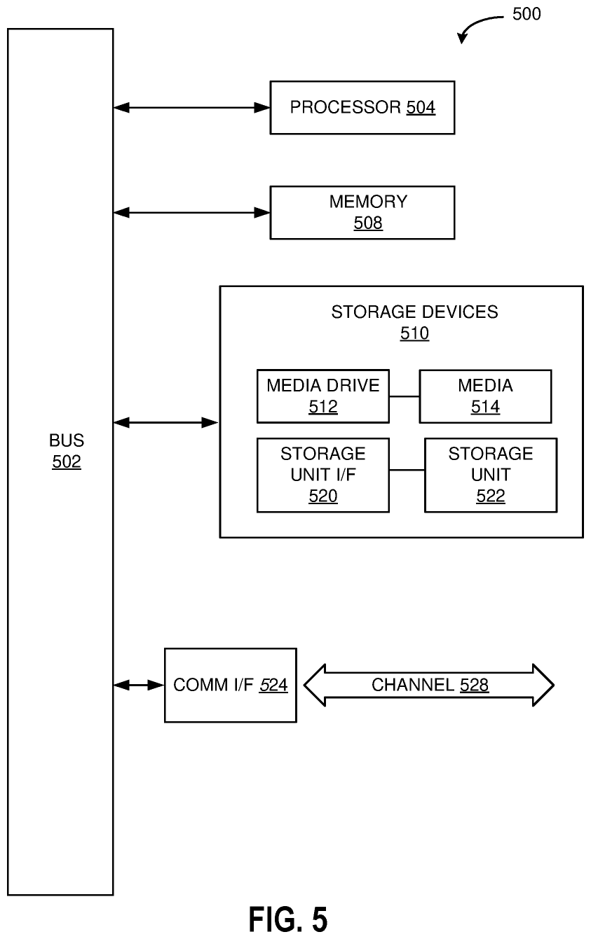

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor 504. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects, and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method comprising:
receiving an image depicting a retail product;
identifying the retail product in the image;
localizing the retail product in the image by zone;
storing metadata of the retail product in the image;
cropping the image about the retail product such the image is bounded by dimensions of the retail product;
adding the cropped image to an asset bin designated for storing assets pertaining to the retail product; and
adding the asset bin to a repository of asset bins, the repository comprising a database of retail products.

2. The computer-implemented method of claim 1, wherein the image comprises one or more controlled zones that are subsets of the image.

3. The computer-implemented method of claim 1, further comprising:
receiving a second image depicting the retail product;
localizing and identifying the retail product in the second image;
cropping the second image about the retail product such that only pixels remain that are associated with the retail product; and
adding the cropped second image to the asset bin corresponding to the respective retail product.

4. The computer-implemented method of claim 1, further comprising:
receiving an additional plurality of images; and
determining that a number of total images exceeds a threshold number of needed images.

5. The computer-implemented method of claim 4, further comprising displaying information on a client device indicating that sufficient images have been received.

6. The computer-implemented method of claim 1, wherein the image comprises alpha channel pixels.

7. The computer-implemented method of claim 1, wherein cropping the image comprises replacing pixels that do not contain the retail product with zero value alpha channel pixels.

8. The computer-implemented method of claim 1, wherein the image comprises the metadata, wherein the metadata comprises camera identifiers, subzone identifiers, and item identifiers.

9. The computer-implemented method of claim 8, wherein item identifiers comprise at least one of SKU numbers, item name, and item shape.

10. The computer-implemented method of claim 8, wherein item identifiers are determined by receiving information from a client device indicating an item identifier.

11. The computer-implemented method of claim 1, wherein adding the asset bin to the repository comprises adding the asset bin to a configuration file in the repository.

12. A system, comprising:
a plurality of cameras;
a memory; and
at least one processor configured to execute machine-readable instructions stored in the memory to:
receive an image comprising alpha channel pixels;
localize a retail product depicted in the image;
crop the image by replacing pixels that do not contain the retail product with zero value alpha channel pixels;
sort the image to an asset folder corresponding to the retail product; and
add the asset folder to a repository.

13. The system of claim 12, wherein the image comprises one specific zone that is a subset of the image.

14. The system of claim 12, wherein the machine-readable instructions further cause the at least one processor to:
receive a second image depicting the retail product;
identify the retail product in the second image;
localize the retail product in the second image;
generate metadata about the retail product;
crop the second image about the retail product such that an image size corresponds to the pixels containing the retail product; and
add the cropped second image to an asset bin corresponding to a respective retail product.

15. The system of claim 12, wherein the machine-readable instructions further cause the at least one processor to:
receive an additional plurality of images; and
determine that a number of total images exceeds a threshold number of needed images.

16. The system of claim 15, wherein the machine-readable instructions further cause the at least one processor to display information on a client device indicating that sufficient images have been received.

17. The system of claim 12, wherein the image comprises metadata, wherein the metadata comprises camera identifiers, subzone identifiers, and item identifiers.

18. The system of claim 17, wherein item identifiers comprise at least one of SKU numbers, item name, and item shape.

19. The system of claim 17, wherein item identifiers are determined by receiving information from a client device indicating an item identifier.

20. The system of claim 12, wherein the machine-readable instructions further cause the at least one processor to add the asset folder to a configuration file in the repository.
